(19) United States
(12) Patent Application Publication
(10) Pub. No.: US 2026/0010760 A1
(43) Pub. Date: Jan. 8, 2026

(54) INTELLIGENT RESOURCE PREDICTION FOR TENSOR NETWORK CONTRACTION WITH EXECUTION PLAN BASED ON MULTI-AGENT REINFORCEMENT LEARNING APPROACH

(71) Applicant: Dell Products L.P., Round Rock, TX (US)

(72) Inventors: João Victor Da Fonseca Pinto, Rio de Janeiro (BR); Micael Veríssimo de Araújo, Rio de Janeiro (BR); Miguel Paredes Quiñones, Campinas (BR)

(21) Appl. No.: 18/766,411

(22) Filed: Jul. 8, 2024

(51) Int. Cl. G06N 3/045; G06N 3/092; G06N 10/20

(52) U.S. Cl. CPC G06N 3/045; G06N 3/092; G06N 10/20

(57) ABSTRACT

One example method includes creating a TN (tensor network) that represents an entity, obtaining an estimate of computational resources needed to contract the TN, and also obtaining a path through the TN that corresponds to the computational resources, determining an optimal path by optimizing the path to minimize the computational resources needed to contract the TN, given available resources, and using the optimal path as a basis to choose an optimal hardware specification for contracting the TN.

### TECHNOLOGICAL FIELD OF THE DISCLOSURE

Embodiments disclosed herein generally relate to tensor networks. More particularly, at least some embodiments relate to systems, hardware, software, computer-readable media, and methods, for identification and efficient use of computing resources to perform tensor network contractions such as may be implemented, for example, in tensor networks used to simulate the execution of quantum circuits.

### BACKGROUND

Tensors are multi-dimensional arrays of numbers where can be interpreted as a generalization of scalars, vectors, and matrices. A tensor contraction is an important operation where two or more tensors can be contracted by summing over indicated indexes. Here, the contraction of the tensors is equivalent to the standard matrix multiplication formula composed by sum and multiplication operations. Today, manipulating large tensors comes at a high computational cost even with all hardware accelerators, such as GPUs (graphics processing units) for example, improvements. This limitation has inspired techniques for tensor decompositions that would reduce computational complexity, especially in quantum physics, while trying to preserve due to precision the original data that it represents. Such techniques are known as tensor networks.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1a discloses aspects of a first bubbling approach in a tensor network (TN) structure.

FIG. 1b discloses aspects of a second bubbling approach implemented in the same TN disclosed in FIG. 1a.

FIG. 2 discloses aspects of a method according to one embodiment.

FIG. 3 discloses a computing entity configured and operable to perform any of the disclosed methods, processes, and operations.

### DETAILED DESCRIPTION OF SOME EXAMPLE EMBODIMENTS

Embodiments disclosed herein generally relate to tensor networks. More particularly, at least some embodiments relate to systems, hardware, software, computer-readable media, and methods, for identification and efficient use of computing resources to perform tensor network contractions such as may be implemented, for example, in tensor networks used to simulate the execution of quantum circuits.

One example embodiment comprises a method for performing contraction operations in a TN that represents a quantum circuit. The method may optimize a path sequence for the contraction of the TN and, based on the optimized path sequence, determine a minimum amount of time and computing resources needed to consume the entire TN. A simulation of the execution of the quantum circuit represented by the TN may then run, such as on classical computing hardware, by a ‘best’ device or system, using the optimized path sequence.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may predict a most efficient, such as in terms of time and/or computing resources needed, path to contraction of a TN. An embodiment may optimize a contraction of a TN to fit available computing resources. An embodiment may enable achievement of particular goals through the use of a reward function that considers various parameters. Various other advantages of one or more example embodiments will be apparent from this disclosure.

### A. Context for One Example Embodiment

The following is a discussion of aspects of an example context for an embodiment. This discussion is not intended to limit the scope of the claims or this disclosure, or the applicability of the embodiments, in any way.

### A.1 Tensor Networks (TN)

A tensor network (TN) is a collection of tensors where a subset of all indices is contracted. Visually, a TN may take the form a diagram which indicates how to combine several tensors into a single composite tensor in such a way that their values are independent of the order in which the constituent tensors are contracted. One way to think of a tensor network is using a DAG (directed acyclic graph) of a quantum circuit that the TN is to represent.

A common operation employed in TNs is referred to as ‘contraction.’ The contraction operation corresponds to a tensor product followed by a trace between indices of two tensors. This operation is widely used to reduce the number of terms in tensor, making computations using the TN more efficient. The order in which tensors are introduced and contracted is known as bubbling. The bubbling is performed until the entire network is swallowed, that is, until there remains only a single resulting tensor. A bubbling process may be performed using a predefined order. That is, for example, a user may define a contraction path to be taken in a TN by the order that the tensors appear in a quantum circuit represented by the TN. Another bubbling approach may rank the order by the number of vertices in each node. The computation of the contraction operation, for a given TN structure, can be executed in a variety of ways, all yielding the same result, but with very different respective computational costs. For example, the operations (AB) C and A (BC) yield the same result, but the respective time and/or computational cost used to achieve those results may be different due to differences in the dimensions of the associated matrix, which is an example of a rank 2 tensor.

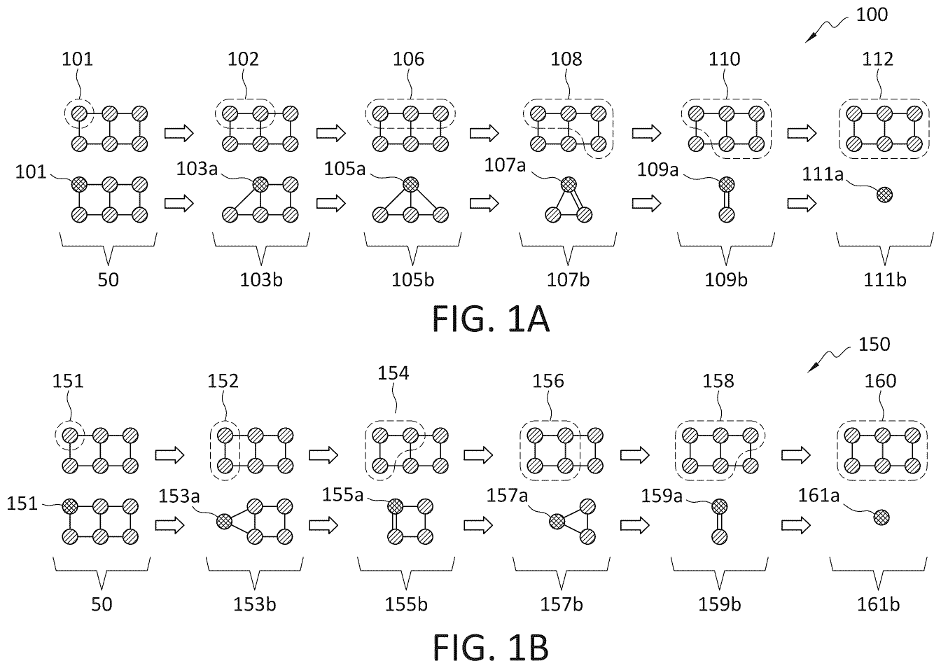

With reference now to the illustrative examples of FIG. 1a and FIG. 1b, two different approaches, or paths, to bubbling in the same TN structure 50 are disclosed. Referring first to the example of FIG. 1a, a bubbling process 100 is disclosed that begins at tensor 101. After the first contraction 102 is performed, the tensor 103a and contracted TN 103b result. The next contraction 106 results in the tensor 105a and a contracted TN 105b. Similarly, the contraction 108 results in the tensor 107a and contracted TN 107b, and the contraction 110 results in the tensor 109a and contracted TN 109b. Finally, the contraction 112 results in a final, single, tensor 111a that constitutes the entire TN 111b.

Referring next to the example of FIG. 1b, a bubbling process 150 is disclosed that is performed on the same TN structure 50 that was used in the example of FIG. 1a. Similar to the bubbling process 100, the bubbling process 150 may begin at tensor 151, corresponding to tensor 101 in the example of FIG. 1a. After the first contraction 152 is performed, the tensor 153a and contracted TN 153b result. The next contraction 154 results in the tensor 155a and a contracted TN 155b. Similarly, the contraction 156 results in the tensor 157a and contracted TN 157b, and the contraction 110 results in the tensor 159a and contracted TN 159b. Finally, the contraction 158 results in a final, single, tensor 161a that constitutes the entire TN 161b.

As the respective examples of FIGS. 1a and 1b collectively illustrate, a variety of different bubbling paths may be taken through a given TN. These paths may vary in terms of the time taken to move along the path, and/or in terms of the computing resources needed to perform the respective bubbling processes. That is, the order of contractions in a TN may influence the complexity and practicality of the contraction computations, highlighting the need for care when planning out contractions.

### A.2 Strategy

From a bubbling perspective, the identification and use of an optimal strategy to decide the order of a TN contraction plays an important role to reduce the computational cost of the entire operation, as disclosed in “Pfeifer, Robert N. C., Jutho Haegeman, and Frank Verstraete. “Faster Identification of Optimal Contraction Sequences for Tensor Networks.” Physical Review E 90, no. 3 (Sep. 30, 2014): 033315. https://doi.org/10.1103/PhysRevE.90.033315” (which is incorporated herein in its entirety by this reference), such as a dynamic programming, depth-first constructive approach, restricting outer products. In the example context of quantum computing (QC), such strategy can be an advantage as it may enable representation of entanglement states, and better simulate quantum circuits using classical resources, where finding the best contraction path is a difficult problem that scales exponentially.

### B. Detailed Discussion of Aspects of One Embodiment

One example embodiment comprises a method that uses Reinforcement Learning (RL) approach and, more specifically, a Multi Agent Reinforcement Learning (MARL) approach, to obtain an approximation for the computational resources needed to contract a TN and their associated path. In this way, an embodiment may optimize a contraction path, or bubbling, by identifying the minimal number of resources to contract the TN, given the resources available. This optimal, minimal, path may then be used to choose a hardware specification that best fits this plan, that is, the path, for execution of the contraction of the TN.

### B.1 Training Agent

In one embodiment, a state space S is defined as a space of graphs, that is, a TN structure, and an action space A is a set of edges to be contracted. A reward function R (.) is defined as the negative of the cost to apply the contraction operation. This cost may be expressed, for example, in terms of the total number of contraction operations and memory consumption for performance of those contraction operations. In an embodiment, this reward function may be adapted to archive the SLA constraints imposed by the user such as, for example, shortest time to execution, lowest memory consumption, or fewest IOs (input/output operations). One embodiment may include weights for each constraint to emphasize one of them, relative to the other constraints, during a training process. Also, one embodiment may include additional, or alternative, constraints in the reward function as needed to suit a specific problem.

During a process for training a MARL, according to one embodiment, the agents are positioned randomly in the nodes of a TN. In one embodiment, one or more of the agents may comprise a Graph Neural Network (GNN) where the input to the GNN is a graph representation of the TN, and the output of the GNN is a distribution over the edges of the TN to be selected for contraction. To take an action a; E A, the agents may choose which edge of the TN will be contracted. This leads to a subsequent state s′ in which the nodes of the TN connected by the selected edge are, and/or have been, contracted, resulting in a new, that is, modified, TN structure, and the state space S′ also defines an associated cost to compute this action.

Next, considering the new state s′, the agent continues to choose another action until the TN is fully contracted, so that only a single tensor remains, and the reward is maximized. It is noted that to avoiding, or reducing, the tensor calculations, an embodiment may only perform calculation of the output dimensions of a contraction operation and the other features observed such as, for example, the number of operations for adding and multiplication, and the size of the tensor output in memory. It is noted that, at each step, the agent may be required to make the decision to balance between: (1) selecting an edge with low cost, in terms of time and/or computing resources for example; or, (2) selecting an edge whose contraction yields a graph that is efficiently contractable in the future.

In one or more embodiments, the computation of the contraction operation given a TN structure may be executed in a variety of ways, all yielding the same result, but with very different respective computational costs. As noted earlier herein, by way of example, both (AB) C and A (BC) yield the same result, but the respective computational cost for each of the operations may be different due to the dimensions of the respective matrixes involved. For a conventional RL approach that may employ only one single agent, the influence of the initial node contraction will produce different costs for the same TN structure. To avoid the effect of this start point node contraction, an embodiment may, instead, perform the training using the MARL strategy.

As one embodiment may use a MARL strategy, the agents in such an approach may share the initial TN structure only at the beginning of the training. After the agents each take their first contraction action, they no longer share the possible actions since there is a possibility of one agent taking an action that removes a possible track for another agent. The best agent, or ‘winner,’ at the end of the training process will be that agent that best matches the SLA constraints, or any other condition defined in a cost function, and will be used to operate as the path finder in the circuit simulation process.

### B.2 Operation

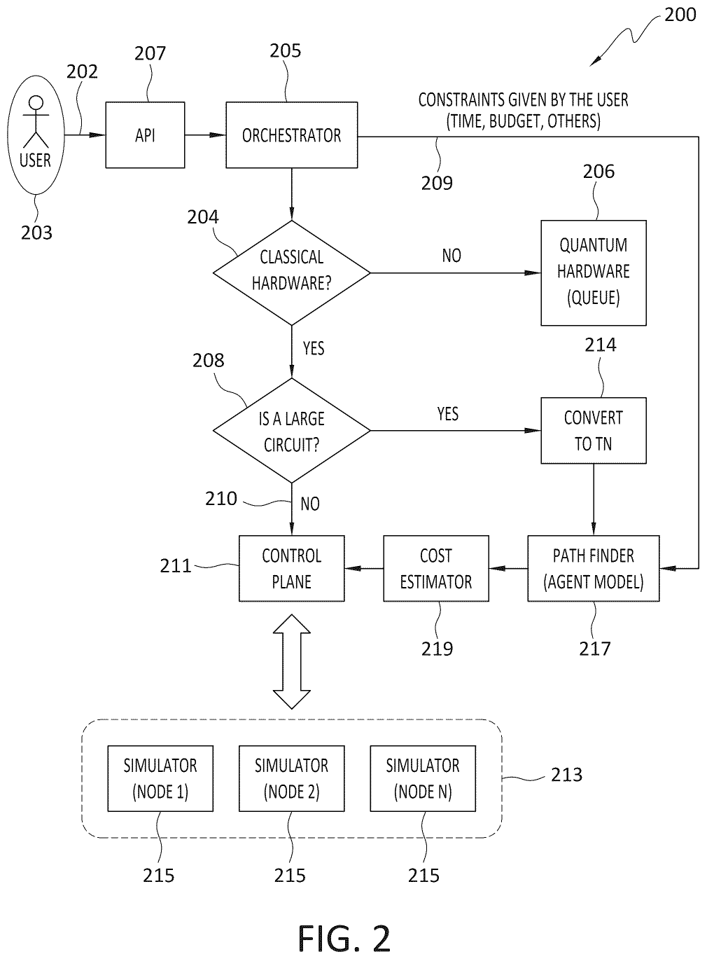

As noted above, the training process may end with the identification of an agent, or ‘winner,’ optimized to achieve, for example, one or more constraints specified in an SLA (service level agreement). Then, this agent may be used is a quantum circuit simulation process when an orchestrator decides to execute the quantum circuit on top of the classical hardware, as part of the simulation process. FIG. 2 discloses an example method 200 comprising an example decision sequence that may be applied, such as by the orchestrator when a workload, such as a new circuit, arrives at a system.

The method 200 may begin at 202 when a user 203 sends a circuit to the orchestrator 205, such as by way of a cloud API platform 207 for example. The orchestrator 205 may then determine 204 whether the circuit should be run on quantum or classical hardware, in order to meet constraints 209, such as the SLA restrictions, and/or other requirements, for the current user profile. If the orchestrator 205 determines 204 that the circuit should be run on quantum hardware, the method 200 may proceed to 206 and the circuit added to a queue for running on the quantum hardware. If, on the other hand, the orchestrator 205 determines 204 that the circuit should be run on classical hardware, that is, the running of the circuit should be performed as a simulation, the method 200 may advance to 208 for a further check.

In particular, the method 200 may perform a check 208 to determine if the size of the circuit exceeds a threshold. If not, the method 200 may advance to 210, passing the circuit to a control plane 211. From the control plane 211, the circuit may be passed to, and executed by, classical computing hardware 213. In an embodiment, the classical computing hardware 213 may comprise various simulators 215, or nodes, configured and operable to run the circuit.

If it is determined 208, on the other hand, that the circuit is too large, that is, the size of the circuit exceeds a threshold, such as in terms of the number of gates of the circuit, then the circuit may be passed 212 to a converter that creates 214 a representation of the circuit. The representation may comprise a TN. Next, the method 200 may obtain, such as from an agent model 217 or other path finder, an agent contraction path sequence for the TN that was created to represents the circuit. The path sequence in this case may be optimized to achieve the SLA restrictions. For example, one agent may generate a path optimized for minimizing memory consumption during a TN contraction process, while another agent may generate a path optimized for minimizing a number of operations needed to carry out a contraction of the TN that represents the circuit.

Next, given the optimized path sequence, the method 200 may use a cost estimator 219 to calculate, for example, a lower bound of memory needed to run the circuit, and may estimate the time to consume the entire TN. The calculations performed by the cost estimator 219 may be a function of the constraint(s) for which the contraction path was optimized. The estimates generated by the cost estimator 219 may then be output 216 to the control plane 211.

In the example method 200, the orchestrator 205 may assign the best simulator 215, considering the lower bound restriction, the time prediction and/or other information provided to run the circuit using the optimized path sequence obtained by the agent model 217. Finally, the simulator 215 may execute the circuit using a TN to follow the path sequence.

In an embodiment, respective parts of the method 200 may be performed by an orchestrator, a converter, an agent model, a cost estimator, and classical computing hardware. Any of the functions of the method 200 may be performed and provided, such as by a cloud site or on-premises, as-a-Service (aaS) to one or more clients or customers. No particular entities, or mode of performance of the method 200 or delivery of a service, is required however, and the foregoing are provided only by way of example.

### B.3 Further Discussion

As disclosed herein, an embodiment may possess various useful features and aspects, none of which are required, and examples of which follow. An embodiment may comprise a MARL model trained to find the best contraction path for a TN that achieves requirements set forth in an SLA. An embodiment may provide a reward function that may be customizes to achieve specific goals, such as constant memory consumption and linear time cost, with respect to a governing SLA. An embodiment may be considered as solving an orchestration problem that presents the following issue: predicting the computational resources needed to perform TN contraction, and obtain the best contraction approach, given the available resources.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### D. Further Example Embodiments

Following are some further example embodiments. These are presented only by way of example and are not intended to limit the scope of this disclosure or the claims in any way.

Embodiment 1. A method, comprising: creating a TN (tensor network) that represents an entity; obtaining an estimate of computational resources needed to contract the TN, and also obtaining a path through the TN that corresponds to the computational resources; determining an optimal path by optimizing the path to minimize the computational resources needed to contract the TN, given available resources; and using the optimal path as a basis to choose an optimal hardware specification for contracting the TN.

Embodiment 2. The method as recited in any preceding embodiment., wherein the entity comprises a quantum circuit.

Embodiment 3. The method as recited in any preceding embodiment., wherein the optimal path is determined using a MARL (multi-agent reinforcement learning) approach, in which each agent of a group of agents involved in the MARL approach is positioned randomly in nodes of the TN.

Embodiment 4. The method as recited in embodiment 3, wherein one of the agents comprises a GNN (graph neural network).

Embodiment 5. The method as recited in embodiment 3, wherein each of the agents traverses the TN and selects one or more edges of the TN that are contracted by the agent to result in a modified TN that is contracted relative to the TN.

Embodiment 6. The method as recited in embodiment 5, wherein each of the agents is guided by a reward function when selecting one of the edges to be contracted.

Embodiment 7. The method as recited in embodiment 5, wherein at each selection of one of the edges, each of the agents balances the selection between selecting an edge with a lowest cost, in terms of time and/or computing resources, to contract, or selecting an edge whose contraction yields a graph that is contractible.

Embodiment 8. The method as recited in embodiment 5, wherein each of the agents continues to select edges for contraction until the TN is fully contracted by that agent.

Embodiment 9. The method as recited in embodiment 8, wherein a winning agent is the agent that determines the optimal path.

Embodiment 10. The method as recited in embodiment 9, wherein the winning agent is usable to operate as a pathfinder through the TN as part of a quantum circuit simulation operation.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

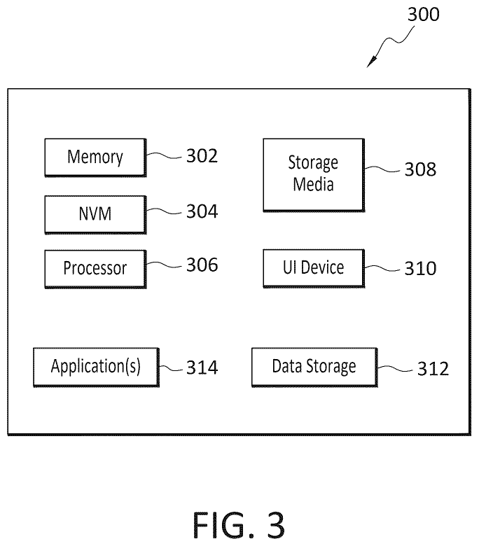

With reference briefly now to FIG. 3, any one or more of the entities disclosed, or implied, by FIGS. 1a-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
creating a TN (tensor network) that represents an entity;
obtaining an estimate of computational resources needed to contract the TN, and also obtaining a path through the TN that corresponds to the computational resources;
determining an optimal path by optimizing the path to minimize the computational resources needed to contract the TN, given available resources; and
using the optimal path as a basis to choose an optimal hardware specification for contracting the TN.

2. The method as recited in claim 1, wherein the entity comprises a quantum circuit.

3. The method as recited in claim 1, wherein the optimal path is determined using a MARL (multi-agent reinforcement learning) approach, in which each agent of a group of agents involved in the MARL approach is positioned randomly in nodes of the TN.

4. The method as recited in claim 3, wherein one of the agents comprises a GNN (graph neural network).

5. The method as recited in claim 3, wherein each of the agents traverses the TN and selects one or more edges of the TN that are contracted by the agent to result in a modified TN that is contracted relative to the TN.

6. The method as recited in claim 5, wherein each of the agents is guided by a reward function when selecting one of the edges to be contracted.

7. The method as recited in claim 5, wherein at each selection of one of the edges, each of the agents balances the selection between selecting an edge with a lowest cost, in terms of time and/or computing resources, to contract, or selecting an edge whose contraction yields a graph that is contractible.

8. The method as recited in claim 5, wherein each of the agents continues to select edges for contraction until the TN is fully contracted by that agent.

9. The method as recited in claim 8, wherein a winning agent is the agent that determines the optimal path.

10. The method as recited in claim 9, wherein the winning agent is usable to operate as a pathfinder through the TN as part of a quantum circuit simulation operation.

11. A non-transitory storage medium having stored therein instructions that are executable by one or more hardware processors to perform operations comprising:
creating a TN (tensor network) that represents an entity;
obtaining an estimate of computational resources needed to contract the TN, and also obtaining a path through the TN that corresponds to the computational resources;
determining an optimal path by optimizing the path to minimize the computational resources needed to contract the TN, given available resources; and
using the optimal path as a basis to choose an optimal hardware specification for contracting the TN.

12. The non-transitory storage medium as recited in claim 11, wherein the entity comprises a quantum circuit.

13. The non-transitory storage medium as recited in claim 11, wherein the optimal path is determined using a MARL (multi-agent reinforcement learning) approach, in which each agent of a group of agents involved in the MARL approach is positioned randomly in nodes of the TN.

14. The non-transitory storage medium as recited in claim 13, wherein one of the agents comprises a GNN (graph neural network).

15. The non-transitory storage medium as recited in claim 13, wherein each of the agents traverses the TN and selects one or more edges of the TN that are contracted by the agent to result in a modified TN that is contracted relative to the TN.

16. The non-transitory storage medium as recited in claim 15, wherein each of the agents is guided by a reward function when selecting one of the edges to be contracted.

17. The non-transitory storage medium as recited in claim 15, wherein at each selection of one of the edges, each of the agents balances the selection between selecting an edge with a lowest cost, in terms of time and/or computing resources, to contract, or selecting an edge whose contraction yields a graph that is contractible.

18. The non-transitory storage medium as recited in claim 15, wherein each of the agents continues to select edges for contraction until the TN is fully contracted by that agent.

19. The non-transitory storage medium as recited in claim 18, wherein a winning agent is the agent that determines the optimal path.

20. The non-transitory storage medium as recited in claim 19, wherein the winning agent is usable to operate as a pathfinder through the TN as part of a quantum circuit simulation operation.
